(19) United States
(12) Patent Application Publication
(10) Pub. No.: US 2026/0166950 A1
(43) Pub. Date: Jun. 18, 2026

(54) VEHICULAR AIR CONDITIONER

(71) Applicant: Hanon Systems, Daejeon (KR)

(72) Inventors: Hwan Kyu Cho, Daejeon (KR); Jae Woo Ko, Daejeon (KR); Ki Jung Park, Daejeon (KR); Ki Man Jeon; Gyu Ik Han, Daejeon (KR)

(21) Appl. No.: 18/853,429

(22) PCT Filed: Aug. 24, 2023
(86) PCT No.: PCT/KR2023/012594

§ 371 Date: Oct. 2, 2024

(30) Foreign Application Priority Data
Sep. 1, 2022 (KR) 10-2022-0110624
Sep. 1, 2022 (KR) 10-2022-0110625

(51) Int. Cl. B60H 1/00; B60H 1/24

(52) U.S. Cl. CPC B60H 1/00671; B60H 1/00564; B60H 1/24

(57) ABSTRACT

A vehicular air conditioner includes: a temperature door configured to control temperature of air discharged into a passenger room by controlling an opening degree of a cold air flow path of an air conditioning case and an opening degree of a hot air flow path of the air conditioning case; mode doors installed in discharge vents and configured to control a discharge direction of the air with respect to the passenger room according to air discharge modes; and a control part configured to variably control opening positions of the mode doors according to the opening position of the temperature door for the cold and hot air flow paths.

### DESCRIPTION

### Technical Field

The present invention relates to a vehicular air conditioner, and more particularly, a vehicular air conditioner capable of improving a control structure between a temperature door and mode doors to thereby prevent an excessive temperature difference between discharged air on the floor vent side and discharged air on the defrosting vent side, which may occur during the control of a specific opening position range of a temperature door under a floor mode condition, and the resulting decrease in comfort in a passenger room.

### Background Art

As shown in FIG. 1, the vehicular air conditioner includes an air conditioning case 10. A cooling heat exchanger 12, a heating heat exchanger 14, a temperature door 15, and a plurality of mode doors 16, 17 and 18 are installed in the internal flow path 10a of the air conditioning case 10.

The cooling heat exchanger 12 cools the air blown into the passenger room along the internal flow path 10a.

The heating heat exchanger 14 is installed on a hot air flow path 10c among the cold air flow path 10b and hot air flow path 10c branched from the internal flow path 10a, and is configured to heat the air blown into the passenger room along the hot air flow path 10c.

The temperature door 15 is a sliding door installed between the cold air flow path 10b and the hot air flow path 10c, and is configured to adjust the opening degree of the cold air flow path 10b and the hot air flow path 10c.

In particular, the opening degrees of the cold and hot air flow paths 10b and 10c are controlled in real time according to the internal and external air temperatures. Accordingly, the temperature of the air blown into the passenger room is adjusted to an optimal state.

The cold air flow path 10b is branched from the internal flow path 10a to both upper and lower sides with the hot air flow path 10c interposed therebetween. A pair of upper and lower temperature doors 15 are provided in accordance with the branching structure of the upper and lower cold air flow paths 10b.

The temperature doors 15 are installed on the upper and lower sides of the hot air flow path 10c, respectively, and is configured to slide toward the upper and lower cold air flow paths 10b to adjust the opening degrees of the cold air flow paths 10b and the hot air flow path 10c.

Hereinafter, the cold air flow path 10b on the upper side is referred to as an upper cold air flow path portion 10b-1, and the cold air flow path 10b on the lower side is referred to as a lower cold air flow path portion 10b-2.

The hot air flow path 10c on the upper side is referred to as an upper hot air flow path portion 10c-1, and the hot air flow path 10c on the lower side is referred to as a lower hot air flow path portion 10c-2. In addition, the temperature door 15 installed between the upper cold and hot air flow path portions 10b-1 and 10c-1 is referred to as a first temperature door 15a, and the temperature door 15 installed between the lower cold and hot air flow path portions 10b-2 and 10c-2 is referred to as a second temperature door 15b.

Meanwhile, the upper cold and hot air flow path portions 10b-1 and 10c-1 and the lower cold and hot air flow path portions 10b-2 and 10c-2 are configured so that their downstream sides are all merged.

Accordingly, the cold air flowing along the upper and lower cold air flow path portions 10b-1 and 10b-2 and the hot air flowing along the upper and lower hot air flow path portions 10c-1 and 10c-2 can be mixed by being joined with each other.

Thus, the mixed hot and cold air can be supplied into the passenger room through the vents 16a, 17a and 18a of the respective mode doors 16, 17 and 18 while being kept at an appropriate temperature.

In general, the downstream sides of the upper cold and hot air flow path portions 10b-1 and 10c-1 are merged with each other on the side of the defrosting door 16 and the vent door 17 among the mode doors 16, 17 and 18, and the downstream sides of the lower cold and hot air flow path portion 10b-2 and 10c-2 are merged with each other on the side of the floor door 18.

Therefore, the cold and hot air mixed on the downstream side of the upper cold and hot air flow path portions 10b-1 and 10c-1 is supplied into the passenger room mainly through the defrosting vent 16a on the defrosting door 16 side and the face vent 17a on the vent door 17 side.

The cold and hot air mixed on the downstream side of the lower cold and hot air flow path portions 10b-2 and 10c-2 is supplied into the passenger room mainly through the floor vent 18a on the floor door 18 side.

Hereinafter, the downstream merging point of the upper cold and hot air flow path portions 10b-1 and 10c-1 is referred to as a first air mixing area A1, and the downstream merging point of the lower cold and hot air flow path portions 10b-2 and 10c-2 is referred to as a second air mixing area A2.

Referring again to FIG. 1, the mode doors 16, 17 and 18 include a defrosting door 16, a vent door 17, and a floor door 18. These mode doors 16, 17 and 18 control the direction of discharge of the air supplied into the passenger room by adjusting the air distribution for each part of the passenger room.

In particular, the mode doors 16, 17 and 18 are controlled in a vent mode in which air is discharged toward the passenger's face, a bi-level mode in which air is discharged toward the floor surface of the passenger room and the passenger's face, a floor mode in which air is discharged toward the floor surface of the passenger room, a mixing mode in which air is discharged toward the window and the floor surface of the passenger room, and a defrosting mode in which air is discharged toward the window.

The mode doors 16, 17 and 18 controlled in this way adjust the opening degrees of the corresponding vents 16a, 17a and 18a according to each air discharge mode and adjust the air distribution for each part of the passenger room, thereby controlling the discharge direction of the air supplied to the passenger room.

However, this conventional air conditioner has a disadvantage in that, when the temperature door 15 is controlled to fall within a specific opening position range during the opening position control of the temperature door 15 for the cold and hot air flow paths 10b and 10c under a specific air discharge mode condition, excessive discharged air temperature difference is generated between the respective discharge vents 16a, 17a and 18a.

For example, as shown in FIG. 2, when the opening position of the temperature door 15 is controlled to fall within a specific intermediate range R between the cold and hot air flow paths 10b and 10c during the control of the opening position of the temperature door 15 for the cold and hot air flow paths 10b and 10c in a state in which the air discharge mode is the floor mode, an excessive temperature difference X is generated between the air discharged through the floor vent 18a on the floor surface side of the passenger room and the air discharged through the defrosting vent 16a on the window side.

In particular, even when the air discharge mode is the floor mode, the defrosting vent 16a is opened at a certain degree so that air is discharged in an amount corresponding to about 30% of the total air discharge amount.

However, as described above, when the opening position of the temperature door 15 is controlled to fall within a specific intermediate range R, the amount of the air flowing toward the defrosting vent 16a is relatively small.

Therefore, most of the cold air in the upper cold air flow path portion 10b-1 flows toward the defrosting vent 16a without being sufficiently mixed with the hot air in the upper hot air flow path 10c-1 and is discharged into the passenger room as it is.

Therefore, an excessive temperature difference is generated between the air temperature on the side of the defrosting vent 16a through which the cold air in the upper cold air flow path portion 10b-1 is discharged as it is, and the air temperature on the side of the floor vent 18a through which most of the hot air in the upper and lower hot air flow path portions 10c-1 and 10c-2 is discharged.

Thus, excessive temperature difference is generated between the upper and lower parts of the passenger room, which significantly reduces comfort in the passenger room.

In particular, the floor mode is mainly used in the heating mode. If the discharged air temperature on the defrosting vent 16a side is too low compared to the discharged air temperature on the floor vent 18a side, the passenger inside the passenger room may feel very cold.

### DETAILED DESCRIPTION OF THE INVENTION

### Technical Task

In view of the problems inherent in the prior art, it is an object of the present invention to provide a vehicular air conditioner capable of improving a control structure between a temperature door and mode doors to thereby prevent an excessive flow of a cold air toward a defrosting vent side, which may occur during the control of a specific opening position range of a temperature door under a floor mode condition.

Another object of the present invention is to provide a vehicular air conditioner capable of preventing excessive temperature difference between a discharged air on the floor vent side and discharged air on the defrosting vent side, which may occur during the control of a specific opening position range of a temperature door under a floor mode condition, by adopting the configuration that can prevent the excessive flow of the cold air toward the defrosting vent side, which may occur during the control of the temperature door to the specific opening position range under the floor mode condition.

A further object of the present invention is to provide a vehicular air conditioner capable of preventing a decrease in comfort in a passenger room due to excessive temperature difference between discharged air temperature on the floor vent side and discharged air temperature on the defrosting vent side, by adopting the configuration that can prevent the excessive temperature difference between the discharged air temperature on the floor vent side and the discharged air temperature on the defrosting vent side, which may occur during the control of the temperature door to the specific opening position range under the floor mode condition.

### Means to Solve the Task

According to one embodiment of the present invention, there is provided a vehicular air conditioner, including: a temperature door configured to control temperature of air discharged into a passenger room by controlling an opening degree of a cold air flow path of an air conditioning case and an opening degree of a hot air flow path of the air conditioning case; mode doors installed in discharge vents and configured to control a discharge direction of the air with respect to the passenger room according to air discharge modes; and a control part configured to variably control opening positions of the mode doors according to the opening position of the temperature door for the cold and hot air flow paths.

The discharge vents may include a defrosting vent, a face vent and a floor vent, the mode doors may include a defrosting door configured to control an opening degree of the defrosting vent, a face door configured to control an opening degree of the face vent and a floor door configured to control an opening degree of the floor vent, and the control part is configured to variably control an opening position of the defrosting door according to an opening position of the temperature door for the cold and hot air flow paths.

When the opening position of the temperature door for the cold and hot air flow paths is controlled to fall within a specific range under a floor mode condition in which the floor vent and the defrosting vent are opened and the face vent is closed, the control part may enter a temperature difference compensation mode and may control the opening position of the defrosting door among the mode doors so as to further open the defrosting vent by a preset degree.

When the opening position of the temperature door for the cold air flow path falls within a range of a preset lower limit or higher and a preset upper limit or lower under the floor mode condition, the control part may enter the temperature difference compensation mode and may control the opening position of the defrosting door so as to further open the defrosting vent by a preset degree.

The vehicular air conditioner may further include: a mode cam configured to adjust the positions of the mode doors according to a rotation position of the mode cam so as to control the mode doors in a specific air discharge mode, wherein the control part may be configured to control the mode cam so as to change the opening positions of the mode doors depending on the opening position of the temperature door for the cold and hot air flow paths.

The discharge vents may include a defrosting vent, a face vent and a floor vent, the mode doors may include a defrosting door configured to control an opening degree of the defrosting vent, a face door configured to control an opening degree of the face vent and a floor door configured to control an opening degree of the floor vent, and the control part may be configured to control the mode cam so as to change the opening position of the defrosting door when the opening position of the temperature door for the cold and hot air flow paths is controlled to fall within a specific range.

The mode cam may have a plurality of slots configured to control the positions of the mode doors when rotated, the control part may include a mode cam control part configured to enter a temperature difference compensation mode and rotate the mode cam to a temperature difference compensation mode position when the opening position of the temperature door for the cold and hot air flow paths falls within a range of a preset lower limit or higher and a preset upper limit or lower under a floor mode condition in which the floor vent and the defrosting vent are opened and the face vent is closed, and the slots of the mode cam may be formed so as to change the opening position of the defrosting door among the mode doors when the mode cam is rotated to the temperature difference compensation mode position.

The slots of the mode cam may include a defrosting door slot configured to control the opening position of the defrosting door on the window side, a vent door slot configured to control the opening position of the vent door on the passenger face side, and a floor door slot configured to control the opening position of the floor door on the floor surface side in the passenger room, each of the slots may have a floor mode section for controlling each of the mode doors at a floor mode position to move to a specific opening position, the floor mode sections of the vent door slot and the floor door slot may be configured to have idle rotation trajectories having the same distance from a central axis of the mode cam so as not to change the opening positions of the vent door and the floor door when the mode cam is rotated to the temperature difference compensation mode position, and the floor mode section of the defrosting door slot may be configured to have a curved trajectory with different distances from the center axis of the mode cam so as to change the opening position of the defrosting door when the mode cam is rotated to the temperature difference compensation mode position

The floor mode section of the defrosting door slot may have a trajectory that allows the defrosting door to move so as to further open the defrosting vent by a preset degree when the mode cam is rotated to the temperature difference compensation mode position.

### Effect of the Invention

According to the vehicular air conditioner of the present invention, the defrosting vent is further opened when the temperature door is controlled to fall within a specific opening position range under a floor mode condition. Therefore, it is possible to prevent the excessive flow of the cold air toward the defrosting vent side, which may occur during the control of the temperature door to the specific opening position range under the floor mode condition.

In addition, since the excessive flow of the cold air toward the defrosting vent side can be prevented, it is possible to prevent the excessive temperature difference between the discharged air temperature on the floor vent side and the discharged air temperature on the defrosting vent side, which may occur during the control of the temperature door to the specific opening position range under the floor mode condition.

In addition, since the excessive temperature difference between the discharged air temperature on the floor vent side and the discharged air temperature on the defrosting vent side can be prevented, it is possible to prevent the decrease in comfort in the passenger room due to the excessive temperature difference between the discharged air temperature on the floor vent side and the discharged air temperature on the defrosting vent side.

### BRIEF DESCRIPTION OF THE DRAWINGS

FIG. 1 is a view showing a conventional vehicular air conditioner.

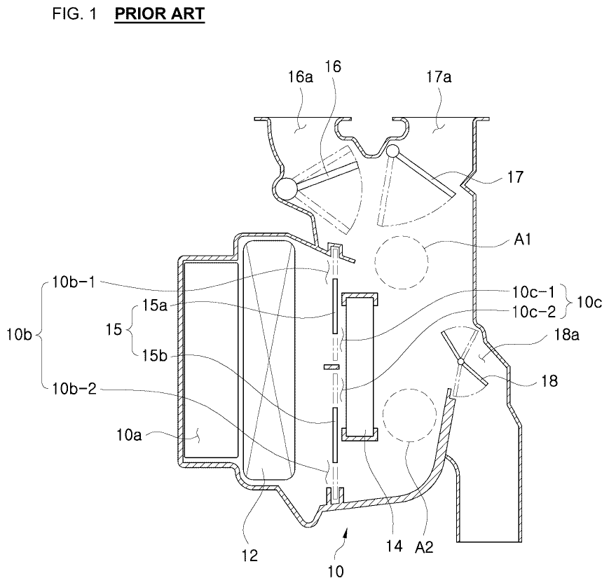

FIG. 2 is a view showing an operation example of the conventional vehicular air conditioner, and is a graph showing a temperature difference between a discharged air temperature on the floor vent side and a discharged air temperature on the defrosting vent side depending on a temperature door opening position under a floor mode condition.

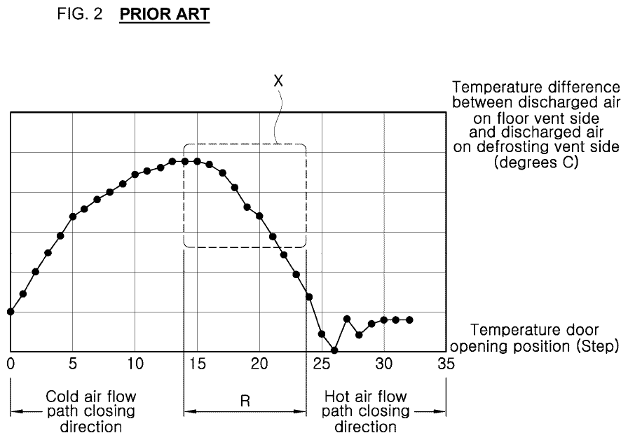

FIG. 3 is a view showing a vehicular air conditioner according to a first embodiment of the present invention.

FIG. 4 is a diagram showing an operation of the vehicular air conditioner according to the first embodiment of the present invention.

FIG. 5 is a graph showing the effect of the vehicular air conditioner according to the first embodiment of the present invention, and is a graph showing temperature difference between discharged air temperature on the floor vent side and discharged air temperature on the defrosting vent side depending on the temperature door opening position under a floor mode condition compared to the conventional one.

FIG. 6 is a view showing an operation example of the vehicular air conditioner according to the first embodiment of the present invention, and is a graph showing an opening position of a defrosting door depending on the temperature door opening position under a floor mode condition.

FIG. 7 is a flowchart showing an operation example of the vehicular air conditioner according to the first embodiment of the present invention.

FIG. 8 is a view showing a vehicular air conditioner according to a second embodiment of the present invention.

FIG. 9 is a view showing an operation example of the vehicular air conditioner according to the second embodiment of the present invention.

FIG. 10 is a view showing in detail a slot structure of a mode cam constituting the vehicular air conditioner according to the second embodiment of the present invention.

FIG. 11 is a graph showing the effect of the vehicular air conditioner according to the second embodiment of the present invention, and is a graph showing temperature difference between discharged air temperature on the floor vent side and discharged air temperature on the defrosting vent side depending on the temperature door opening position under a floor mode condition compared to the conventional one.

FIG. 12 is a view showing an operation example of the vehicular air conditioner according to the second embodiment of the present invention, and is a graph showing an opening position of a defrosting door depending on the temperature door opening position under a floor mode condition.

FIG. 13 is a flowchart showing an operation example of the vehicular air conditioner according to the second embodiment of the present invention.

### BEST MODE TO IMPLEMENT THE INVENTION

Preferred embodiments of a vehicular air conditioner according to the present invention will now be described in detail with reference to the accompanying drawings (The same components as those of the prior art described above are designated by like reference numerals).

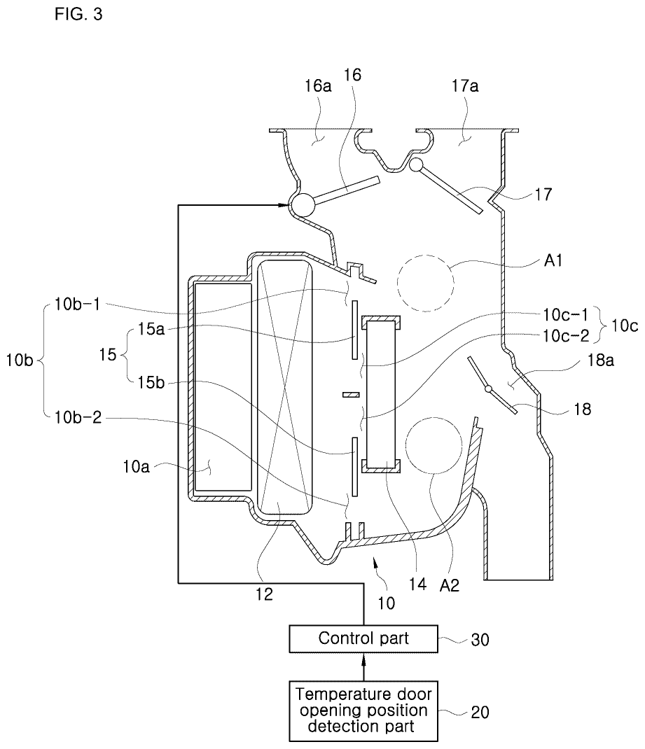

Prior to describing the features of the vehicular air conditioner according to the present invention, the general configuration of the vehicular air conditioner will be briefly described with reference to FIG. 3.

The vehicular air conditioner includes an air conditioning case 10. A cooling heat exchanger 12, a heating heat exchanger 14, temperature doors 15, and a plurality of mode doors 16, 17 and 18 are installed in the internal flow path 10a of the air conditioning case 10.

The cooling heat exchanger 12 cools the air blown into the passenger room along the internal flow path 10a.

The heating heat exchanger 14 is installed on a hot air flow path 10c among the cold air flow path 10b and hot air flow path 10c branched from the internal flow path 10a, and is configured to heat the air blown into the passenger room along the hot air flow path 10c.

The temperature doors 15 are a pair of sliding doors, and includes a first temperature door 15a installed between the upper cold and hot air flow path portions 10b-1 and 10c-1, and a second temperature door 15b installed between the lower cold and hot air flow path portions 10b-2 and 10c-2.

The temperature doors 15 move between the upper cold and hot air flow path portions 10b-1 and 10c-1 and the lower cold and hot air flow path portions 10b-2 and 10c-2 to control the opening degrees of the upper cold and hot air flow path portions 10b-1 and 10c-1 and the lower cold and hot air flow path portions 10b-2 and 10c-2. Accordingly, the temperature doors 15 control the temperature of the air blown into the passenger room.

The downstream sides of the upper cold and hot air flow path portions 10b-1 and 10c-1 are merged to form a first air mixing area A1, and the downstream sides of the lower cold and hot air flow path portions 10b-2 and 10c-2 are merged to form a second air mixing area A2.

The first air mixing area A1 is formed adjacent to the defrosting vent 16a on the defrosting door 16 side and the face vent 17a on the vent door 17 side. Therefore, the cold and hot air of the upper cold and hot air flow path portions 10b-1 and 10c-1 mixed in the first air mixing area A1 is mainly supplied to the upper part of the passenger room through the defrosting vent 16a and the face vent 17a.

The second air mixing area A2 is formed adjacent to the floor vent 18a on the floor door 18 side. Therefore, the cold and hot air of the lower cold and hot air flow path portions 10b-2 and 10c-2 mixed in the second air mixing area A2 is mainly supplied to the floor surface part inside the passenger room through the floor vent 18a.

The mode doors 16, 17 and 18 include a defrosting door 16, a vent door 17, and a floor door 18.

The mode doors 16, 17 and 18 are controlled in a vent mode for the passenger face, a bi-level mode for the floor surface inside the passenger room and the passenger face, a floor mode for the floor surface inside the passenger room, a mixing mode for the window glass and the floor surface inside the passenger room, and a defrosting mode for the window.

These mode doors 16, 17 and 18 control the air distribution to the respective parts of the passenger room by adjusting the opening degree of the corresponding vents 16a, 17a and 18a according to the respective air discharge modes. Accordingly, the discharge direction of the air supplied to the passenger room can be controlled.

### First Embodiment

Next, the features of a vehicular air conditioner according to a first embodiment of the present invention will be described in detail with reference to FIGS. 3 to 6.

Referring first to FIG. 3, the vehicular air conditioner according to the first embodiment of the present invention includes a temperature door opening position detection part 20.

The temperature door opening position detection part 20 includes a door detection sensor (not shown) that detects the position of the temperature door 15.

The door detection sensor detects the opening position of the temperature door 15 for the cold and hot air flow paths 10b and 10c and inputs the detected opening position to a control part 30 described below.

In some cases, the temperature door opening position detection part 20 may include an automatic control unit (not shown) that automatically controls the air conditioner.

The automatic control unit automatically controls the opening position of the temperature door 15 for the cold and hot air flow paths 10b and 10c according to the temperature conditions inside and outside the passenger room, and outputs a signal for automatic control of the temperature door 15 so as to detect the opening position of the temperature door 15 for the cold and hot air flow paths 10b and 10c.

The air conditioner according to the first embodiment of the present invention further includes a control part 30.

The control part 30, which is equipped with a microprocessor, is configured to variably control the opening position of a specific mode door 16, 17 or 18 according to the opening position of the temperature door 15 inputted from the temperature door opening position detection part 20 in a specific air discharge mode.

In particular, the control part 30 is configured to variably control the opening position of a specific mode door 16, 17 or 18 when the opening position of the temperature door 15 is controlled to fall within a specific range under a specific air discharge mode condition, and to variably control the opening position of the mode door 16 on the vent 16a, which generates the largest temperature difference compared to others, among the respective vents 16a, 17a and 18a for the mode doors 16, 17 and 18.

To explain this in more detail, the control part 30 receives, in real time, the opening position of the temperature door 15 for the cold and hot air flow paths 10b and 10c through the temperature door opening position detection part 20 in a specific air discharge mode, for example, in a floor mode in which the floor vent 18a and the defrosting vent 16a are opened and the face vent 17a is closed.

At this time, the control part 30 determines whether the opening position of the temperature door 15 received from the temperature door opening position detection part 20 is within a preset specific range.

For example, in terms of the opening degree of the cold air flow path 10b, the control part 30 determines whether the opening position of the temperature door 15 for the cold air flow path 10 b is within a range of 40% or more of a preset lower limit and 67% or less of the preset upper limit.

As a result of the determination, if the opening position of the temperature door 15 for the cold air flow path 10 b is within the range of 40% or more of a preset lower limit and 67% or less of the preset upper limit, the control part 30 recognizes that the amount of air currently flowing toward the defrosting vent 16a is relatively small, and most of the cold air in the upper cold air flow path portion 10b-1 flows toward the defrosting vent 16a without being sufficiently mixed with the hot air in the upper hot air flow path portion 10c-1 in the first air mixing area A1.

In particular, the control part 30 recognizes that, as the cold air in the upper cold air flow path portion 10b-1 flows to the defrosting vent 16a side as it is, an excessive temperature difference is generated between the discharged air temperature inside the passenger room on the side of the defrosting vent 16a through which the cold air in the upper cold air flow path portion 10b-1 is discharged as it is and the discharged air temperature inside the passenger room on side of the floor vent 18a through which most of the hot air of the upper and lower hot air flow paths 10c-1 and 10c-2 is discharged.

Based on this recognition, the control part 30 enters a temperature difference compensation mode in which the control part 30 variably controls the opening position of the defrosting door 16 for the defrosting vent 16a.

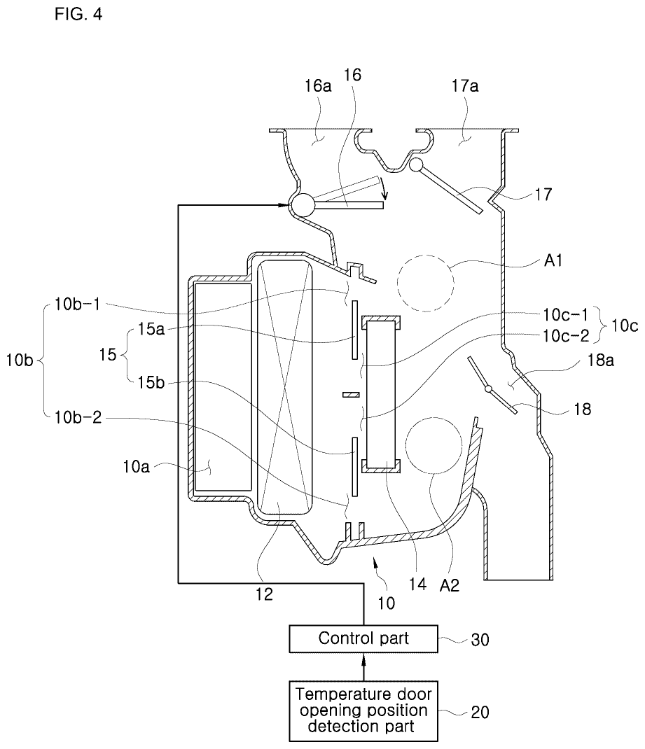

In particular, as illustrated in FIG. 4, the opening position of the defrosting door 16 is controlled so as to further open the defrosting vent 16a by a preset degree.

Therefore, the opening degree of the defrosting vent 16a is increased more than before entering a temperature difference compensation mode. This allows the amount of air flowing toward the defrosting vent 16a to relatively increase.

As a result, the cold air from the upper cold air flow path portion 10b-1 can flow toward the defrosting vent 16a while being sufficiently mixed with the hot air from the upper hot air flow path portion 10c-1 in the first air mixing area A1.

Therefore, the temperature of the air flowing toward the defrosting vent 16a can be increased, thereby increasing the temperature of the air discharged into the passenger room through the defrosting vent 16a.

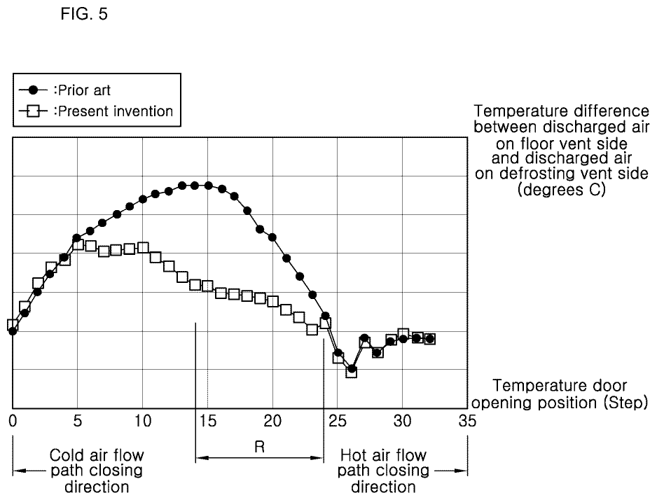

Accordingly, as illustrated in FIG. 5, it is possible to correct and eliminate an excessive temperature difference between the discharged air temperature on the defrosting vent 16a side and the discharged air temperature on the floor vent 18a side, which may be generated when the opening position of the temperature door 15 is controlled to fall within a specific range R under the floor mode condition.

In addition, as shown in FIG. 4, when the defrosting vent 16a is further opened to increase the amount of air flowing toward the defrosting vent 16a, the amount of air passing through the heating heat exchanger 14 relatively increases.

In particular, when the defrosting door 16 is further opened to increase the amount of air flowing toward the defrosting vent 16a, a larger amount of air can move toward the upper hot air flow path portion 10c-1, and thus the amount of air passing through the heating heat exchanger 14 also relatively increases.

As the amount of air passing through the heating heat exchanger 14 increases, the amount of heat exchange on the heating heat exchanger 14 side also increases, thereby increasing the temperature of the air flowing toward the defrosting vent 16a.

Accordingly, the temperature of the air discharged into the passenger room through the defrosting vent 16a can be further increased. This further improves the efficiency of eliminating the temperature difference between the discharged air temperature on the defrosting vent 16a side and the discharged air temperature on the floor vent 18a side.

In addition, when the defrosting vent 16a is further opened to increase the amount of air flowing toward the defrosting vent 16a, the air in the second air mixing area A2 flows toward the first air mixing area A1.

In this air flow process, the air mixing efficiency between the first air mixing area A1 and the second air mixing area A2 increases, thereby further increasing the temperature of the air flowing toward the defrosting vent 16a.

As a result, the temperature difference between the air flowing toward the defrosting vent 16a side and the air flowing toward the floor vent 18a side is eliminated.

Therefore, the efficiency of eliminating the temperature difference between the discharge air temperature on the defrosting vent 16a side and the discharge air temperature on the floor vent 18a side can be further improved.

In addition, when controlling the temperature door 15 to the specific opening position range under the floor mode condition, the control part 30 lowers the pressure in the flow path on the downstream side of the upper cold and hot air flow path portions 10b-1 and 10c-1 by further opening at least one of the mode doors on the downstream side of the upper cold and hot air flow path portions 10b-1 and 10c-1, for example, the defrosting door 16.

In particular, the control part 30 lowers the pressure in the flow path on the defrosting vent 16a side close to the upper cold and hot air flow path portions 10b-1 and 10c-1 among the flow paths on the downstream side of the upper cold and hot air flow path portions 10b-1 and 10c-1.

Therefore, the hot air on the upper hot air flow path portion 10c-1 side can further flow toward the defrosting vent 16a at which the pressure is lowered.

This allows the temperature of the air discharged into the passenger room through the defrosting vent 16a to further rise, thereby eliminating the temperature difference between the discharged air temperature on the defrosting vent 16a side and the discharged air temperature on the floor vent 18a side.

Meanwhile, when entering the temperature difference compensation mode, i.e., when controlling the temperature door 15 a specific opening position range under the floor mode condition, the control part 30 controls the defrosting door 16 so as to further open the defrosting vent 16a, and variably controls the defrosting door 16 so that the opening position of the defrosting door 16 for the defrosting vent 16a varies depending on the opening position of the temperature door 15 for the cold and hot air flow paths 10b and 10c.

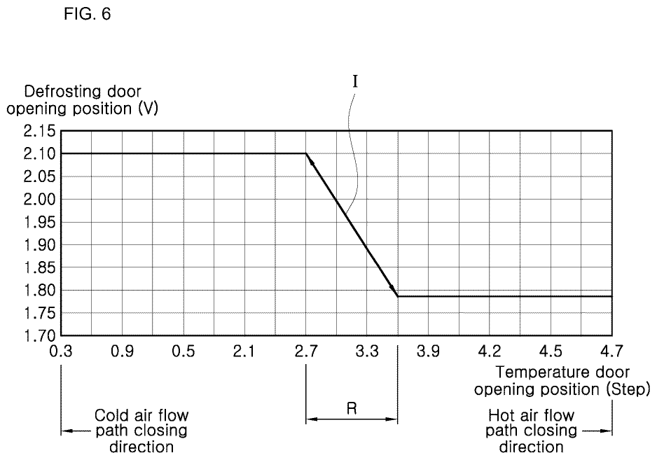

For example, as illustrated in FIG. 6, when controlling a specific opening position range R of the temperature door 15 under a floor mode condition, the opening degree of the defrosting door 16 for the defrosting vent 16a is controlled to increase in inverse proportion to the decrease in the opening degree of the temperature door 15 for the cold air flow path 10b (see “I”).

The reason for this control is that, as the cold air flow path 10b is narrowed, the amount of air flowing toward the defrosting vent 16a is relatively small, so the cold air in the upper cold air flow path portion 10b-1 flows toward the defrosting vent 16a without being sufficiently mixed with the hot air in the upper hot air flow path portion 10c-1.

Accordingly, as the cold air flow path 10b is narrowed, the opening amount of the defrosting vent 16a is increased, so that the flow rate of the air flowing toward the defrosting vent 16a is increased as the cold air flow path 10b is narrowed. This enhances the mixing efficiency of the cold air and the hot air in the upper cold and hot air flow path portions 10b-1 and 10c-1.

As a result, by inducing a rise in the temperature of the discharged air on the defrosting vent 16a side, it is possible to eliminate the temperature difference between the discharged air on the defrosting vent 16a side and the discharged air temperature on the floor vent 18a side.

Referring again to FIG. 3, the control part 30 enters the temperature difference compensation mode and controls the defrosting door 16 so as to further open the defrosting vent 16a, while continuously receiving the opening position of the temperature door 15 in real time from the temperature door opening position detection part 20.

At this time, if the opening position of the temperature door 15 for the cold and hot air flow paths 10b and 10c is not in a preset specific range, for example, if the opening position of the temperature door 15 for the cold air flow path 10 b does not fall within a range of 40% or more of a preset lower limit and 67% or less of a preset upper limit, the control part 30 is released from the temperature difference compensation mode.

The control part 30 released from the temperature difference compensation mode returns the opening position of the defrosting door 16 to the opening position available before entering the temperature difference compensation mode.

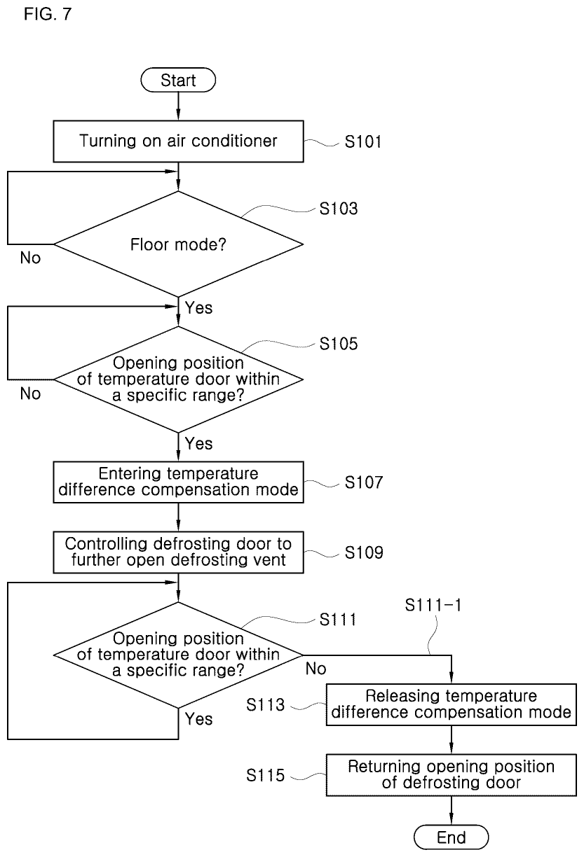

Next, an operation example of the vehicular air conditioner according to the first embodiment of the present invention having such a configuration will be described in detail with reference to FIGS. 3 and 7.

Referring first to FIG. 7, when the vehicular air conditioner is turned on (S101), the control part 30 determines whether the current air discharge mode is a floor mode (S103).

As a result of the determination, if the current air discharge mode is the floor mode, the control part 30 determines whether the opening position of the temperature door 15 for the cold and hot air flow paths 10b and 10c is within a preset specific range (S105).

For example, the control part 30 determines whether the opening position of the temperature door 15 for the cold air flow path 10b is within a range of 40% or more of the preset lower limit and 67% or less of the preset upper limit.

As a result of the judgment, if the opening position of the temperature door 15 for the cold air flow path 10 b is within the range of 40% or more of the preset lower limit and 67% or less of the preset upper limit, the control part 30 recognizes that most of the cold air on the cold air flow path 10b side is currently flowing toward the defrosting vent 16a side to generate excessive temperature difference between the discharged air temperature on the defrosting vent 16a side and the discharged air temperature on the floor vent 18a side. Based on this recognition, the control part 30 enters the temperature difference compensation mode (S107).

The control part 30, which has entered the temperature difference compensation mode, controls the opening position of the defrosting door 16 so as to further open the defrosting vent 16a by a preset degree (S109).

Then, the amount of air flowing toward the defrosting vent 16a relatively increases. Accordingly, the cold air in the upper cold air flow path portion 10b-1 flows toward the defrosting vent 16a while being sufficiently mixed with the hot air of the upper hot air flow path portion 10c-1 in the first air mixing area A1.

As a result, the temperature of the air flowing toward the defrosting vent 16a increases, and the temperature of the air discharged into the passenger room from the defrosting vent 16a increases.

Accordingly, it is possible to correct and eliminate the excessive temperature difference between the discharged air temperature on the defrosting vent 16a side and the discharged air temperature on the floor vent 18a side, which may be generated when the temperature door 15 is controlled to fall within a specific opening position range under the floor mode condition.

Meanwhile, after entering the temperature difference compensation mode, the control part 30 continuously determines whether the opening position of the temperature door 15 for the cold and hot air flow paths 10b and 10c is within the preset specific range (S111).

At this time, if the opening position of the temperature door 15 is not within the preset specific range (S111-1), the control part 30 is released from the temperature difference compensation mode (S113).

Then, the control part 30 released from the temperature difference compensation mode returns the opening position of the defrosting door 16 to the opening position available before entering the temperature difference compensation mode (S115).

### Second Embodiment

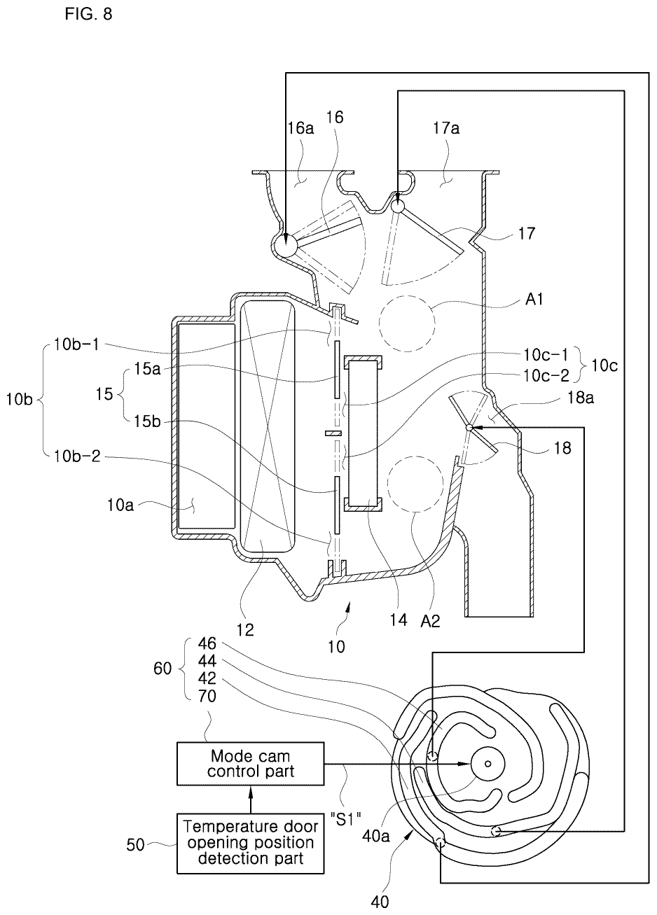

FIGS. 8 to 13 are views showing a vehicular air conditioner according to a second embodiment of the present invention.

Referring first to FIG. 8, the vehicular air conditioner according to the second embodiment has a structure in which the mode doors 16, 17 and 18 are controlled by a mode cam 40.

The mode cam 40 is rotated forward and backwardly by an actuator (40a), and has a number of slots 42, 44 and 46 that can control the positions of the mode doors 16, 17 and 18, and adjusts the positions of the mode doors 16, 17 and 18 according to the rotational positions thereof to control them in a specific air discharge mode.

Just like the vehicular air conditioner of the first embodiment, the vehicular air conditioner of the second embodiment is provided with a temperature door opening position detection part 50.

The temperature door opening position detection part 50, which is a door detection sensor for detecting the position of the temperature door 15, detects the opening position of the temperature door 15 with respect to the cold and hot air flow paths 10b and 10c and inputs the detected portion to the control part 60 described below.

The vehicular air conditioner of the second embodiment includes a control part 60 that variably controls the opening position of a specific mode door 16 according to the opening position of the temperature door 15 inputted from the temperature door opening position detection part 50 in a specific air discharge mode.

The control part 60 is configured to variably control the opening position of a specific mode door 16 when the opening position of the temperature door 15 is controlled to fall within a specific range under a specific air discharge mode condition, and variably control the opening position of the mode door 16 on the vent 16a side in which the largest temperature difference is generated among the vents 16a, 17a and 18a corresponding to the mode doors 16, 17 and 18.

To explain this in more detail, the control part 60 includes a mode cam control part 70 configured to control the mode cam 40 so that the mode cam 40 can be rotated to a specific position when the opening position of the temperature door 15 is controlled to fall within a specific range under a specific air discharge mode condition. The mode cam 40 has slots 42, 44 and 46 configured to change the opening position of a specific mode door 16 when the mode cam 40 is rotated to a specific position.

The mode cam control part 70, which is equipped with a microprocessor, receives in real time from the temperature door opening position detection part 50 the opening position data of the temperature door 15 for the cold and hot air flow paths 10b and 10c in a specific air discharge mode, for example, in a floor mode in which the floor vent 18a and the defrosting vent 16a are opened and the face vent 17a is closed.

At this time, the mode cam control part 70 determines whether the opening position of the temperature door 15 received from the temperature door opening position detection part 50 is within a preset specific range.

For example, in terms of the opening degree of the cold air flow path 10b, the mode cam control part 70 determines whether the opening position (opening degree) of the temperature door 15 for the cold air flow path 10b is within a range of 40% or more of a preset lower limit and 67% or less of a preset upper limit.

As a result of the determination, if the opening position (opening degree) of the temperature door 15 for the cold air flow path 10b is within the range of 40% or more of a preset lower limit and 67% or less of a preset upper limit, the mode cam control part 70 recognizes that the amount of air currently flowing from the upper cold air flow path portion 10b-1 toward the defrosting vent 16a is relatively small so that most of the cold air in the upper cold air flow path portion 10b-1 flows toward the defrosting vent 16a without being sufficiently mixed with the hot air in the upper hot air flow path portion 10c-1.

In particular, the mode cam control part 70 recognizes that, as the cold air in the upper cold air flow path portion 10b-1 flows to the defrosting vent 16a side as it is, an excessive temperature difference is generated between the discharged air temperature inside the passenger room on the side of the defrosting vent 16a through which the cold air in the upper cold air flow path portion 10b-1 is discharged as it is and the discharged air temperature inside the passenger room on side of the floor vent 18a through which most of the hot air of the upper and lower hot air flow path portions 10c-1 and 10c-2 is discharged.

Based on this recognition, the mode cam control part 70 enters a temperature difference compensation mode in which the mode cam control part 70 controls the actuator 40a of the mode cam 40 by outputting a mode cam control signal S1.

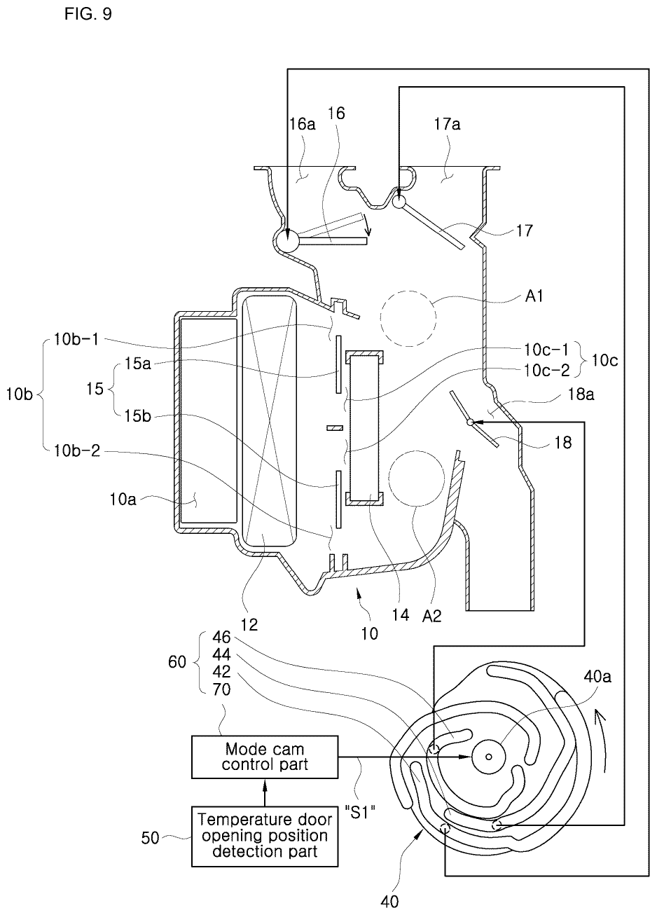

In particular, as shown in FIGS. 8 and 9, the actuator 40a of the mode cam 40 is controlled so that the mode cam 40 that has moved each of the mode doors 16, 17 and 18 to the floor mode position can be rotated to a preset specific position.

Accordingly, each of the mode doors 16, 17 and 18 connected to each of the slots 42, 44 and 46 of the mode cam 40 can be controlled to move from the floor mode position to a specific opening position.

In this regard, the specific opening position of each of the mode doors 16, 17 and 18 controlled by the mode cam 40 is referred to as a “temperature difference compensation mode position.” In addition, the specific position of the mode cam 40 that controls each of the mode doors 16, 17 and 18 to move the temperature difference compensation mode position is also referred to as a “temperature difference compensation mode position.”

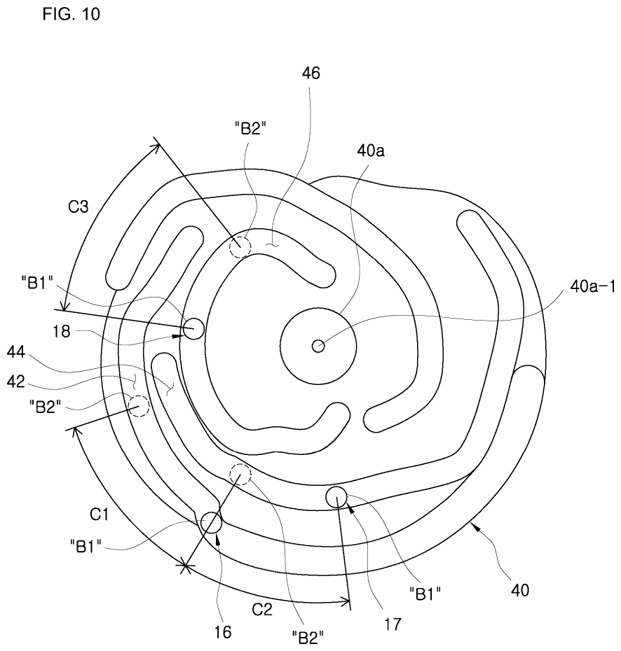

Meanwhile, as shown in FIG. 10, each of the slots 42, 44 and 46 of the mode cam 40 has a floor mode section C1, C2 or C3 for controlling each of the mode doors 16, 17 and 18 to move from a floor mode position B1 to a temperature difference compensation mode position B2.

Among the slots 42, 44 and 46 of the mode cam 40, the vent door slot 44 and the floor door slot 46 for controlling the positions of the vent door 17 and the floor door 18 are configured such that each of the floor mode sections C2 and C3 between the floor mode position B1 and the temperature difference compensation mode position B2 serves as an idle rotation trajectory.

The idle rotation sections C2 and C3 of the vent door slot 44 and the floor door slot 46 are formed to have the same distance from the central axis 40a-1 of the mode cam 40, so that the rotation of the mode cam 40 to the temperature difference compensation mode position does not affect the opening positions of the vent door 17 and the floor door 18.

Accordingly, when the opening position of the temperature door 15 is controlled to fall within a specific range under the floor mode condition, even if the mode cam 40 is rotated to the temperature difference compensation mode position under the control of the mode cam control part 70, the opening position of the vent door 17 and the floor door 18 is maintained at the floor mode position without being changed.

On the other hand, among the slots 42, 44 and 46 of the mode cam 40, the defrosting door slot 42 for controlling the position of the defrosting door 16 is configured so that the floor mode section C1 between the floor mode position B1 and the temperature difference compensation mode position B2 has a trajectory curved so as to have different distances from the central axis 40a-1 of the mode cam 40.

Accordingly, when the opening position of the temperature door 15 is controlled to fall within a specific range under the floor mode condition, if the mode cam 40 is rotated to the temperature difference compensation mode position under the control of the mode cam control part 70, the opening position of the defrosting door 16 is variably controlled.

As a result, when the opening position of the temperature door 15 is controlled to fall within a specific range under the floor mode condition, the opening position of the vent door 17 and the floor door 18 is maintained at the floor mode position, and only the opening position of the defrosting door 16 is changed.

Accordingly, when the opening position of the temperature door 15 is controlled to fall within a specific range under the floor mode condition, the amount and temperature of the air discharged into the passenger room through the defrosting vent 16a can be changed, thereby compensating for the discharged air temperature difference between the defrosting vent 16a side and the floor vent 18a side.

Preferably, the floor mode section C1 of the defrosting door slot 42 for changing the opening degree of the defrosting door 16 has a trajectory curved from the central axis 40a-1 of the mode cam 40 and designed to cause the defrosting door 16 to further open the defrosting vent 16a by a preset degree.

Accordingly, as illustrated in FIG. 9, when the opening position of the temperature door 15 is controlled to fall within a specific range under the floor mode condition, the opening degree of the defrosting vent 16a can be increased more than the opening degree available before entering the temperature difference compensation mode.

This allows the amount of the air flowing toward the defrosting vent 16a to relatively increase.

As a result, the cold air in the upper cold air flow path portion 10b-1 is sufficiently mixed with the hot air in the upper hot air flow path portion 10c-1 in the first air mixing area A1 and is then allowed to flow toward the defrosting vent 16a.

Thus, the temperature of the air flowing toward the defrosting vent 16a can be increased, thereby increasing the temperature of the air discharged into the passenger room through the defrosting vent 16a.

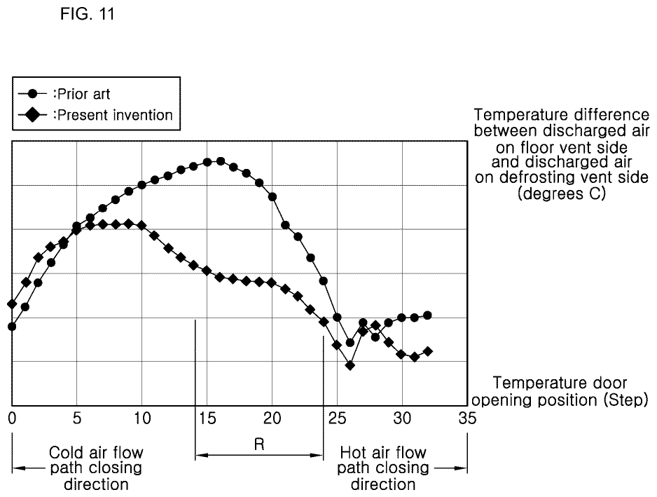

Accordingly, as illustrated in FIG. 11, when the opening position of the temperature door 15 is controlled to fall within a specific range R under the floor mode condition, it is possible to correct and eliminate an excessive temperature difference between the discharged air on the defrosting vent 16a side and the discharged air on the floor vent 18a side.

In addition, as shown in FIG. 9, when the defrosting vent 16a is further opened and the amount of the air flowing toward the defrosting vent 16a is increased, the amount of the air passing through the heating heat exchanger 14 is also relatively increased.

In particular, when the defrosting door 16 is further opened to increase the amount of the air flowing toward the defrosting vent 16a, a larger amount of air can flow toward the upper hot air flow path portion 10c-1, and thus the amount of the air passing through the heating heat exchanger 14 is also relatively increased.

As the amount of the air passing through the heating heat exchanger 14 increases, the amount of heat exchange on the side of the heating heat exchanger 14 is also increased, thereby increasing the temperature of the air flowing toward the defrosting vent 16a.

Accordingly, the temperature of the air discharged into the passenger room through the defrosting vent 16a can be further increased, thereby further improving the efficiency of eliminating the temperature difference between the discharged air on the defrosting vent 16a side and the discharged air on the floor vent 18a side.

In addition, when the defrosting vent 16a is further opened to increase the amount of the air flowing toward the defrosting vent 16a, the air in the second air mixing area A2 flows toward the first air mixing area A1, at which time the air mixing efficiency between the first air mixing area A1 and the second air mixing area A2 can be enhanced to further increase the temperature of the air flowing toward the defrosting vent 16a.

As a result, the temperature difference between the air flowing on the defrosting vent 16a side and the air flowing on the floor vent 18a side is eliminated.

Therefore, it is possible to further improve the efficiency of eliminating the temperature difference between the discharged air on the defrosting vent 16a side and the discharged air on the floor vent 18a side.

In addition, the control part 60 controls the mode cam 40 to further open at least one of the mode doors on the downstream side of the upper cold and hot air flow path portions 10b-1 and 10c-1, for example, the defrosting door 16, when controlling the temperature door 15 to the specific opening position range under the floor mode condition, thereby lowering the pressure in the flow path on the downstream side of the upper cold and hot air flow path portions 10b-1 and 10c-1.

In particular, the control part 60 lowers the pressure in the flow path on the side of the defrosting vent 16a close to the upper cold and hot air flow path portions 10b-1 and 10c-1 among the flow path portions on the downstream side of the upper cold and hot air flow path portions 10b-1 and 10c-1.

Therefore, a larger amount of hot air in the upper hot air flow path portion 10c-1 can flow more toward the defrosting vent 16a side where the pressure is lowered.

This can further increase the temperature of the air discharged into the passenger room through the defrosting vent 16a, thereby eliminating the temperature difference between the discharged air on the defrosting vent 16a side and the discharged air on the floor vent 18a side.

Referring again to FIGS. 8 and 9, the control part 60 controls the defrosting door 16 so as to further open the defrosting vent 16a when entering the temperature difference compensation mode, i.e., when controlling the temperature door 15 to a specific opening position range under the floor mode condition, and variably controls the defrosting door 16 so that the opening position of the defrosting door 16 for the defrosting vent 16a varies depending on the opening position of the temperature doors 15 for the cold and hot air flow paths 10b and 10c.

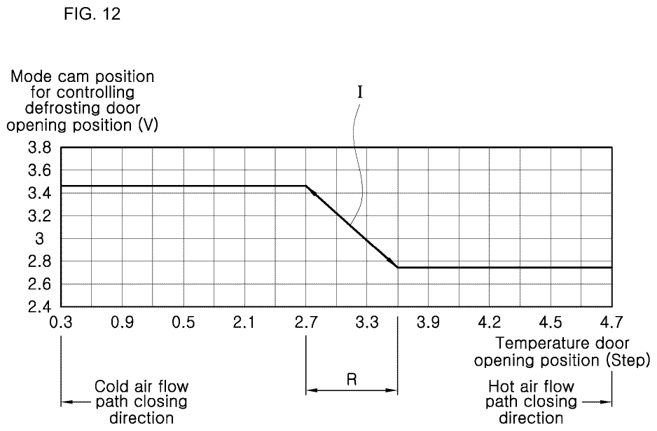

For example, as illustrated in FIG. 12, when controlling a specific opening position range R of the temperature door 15 under the floor mode condition, the opening degree of the defrosting door 16 for the defrosting vent 16a is controlled to increase in inverse proportion to the decrease in the opening degree of the temperature door 15 for the cold air flow path 10b (see “I”).

To achieve this control, the mode cam control part 70 rotates the mode cam 40 to the temperature difference compensation mode position when controlling the temperature door 15 to the specific opening position range under the floor mode condition, so that the rotation position of the mode cam 40 varies depending on the opening position of the temperature door 15 for the cold and hot air flow paths 10b and 10c.

In particular, the mode cam control part 70 variably controls the mode cam 40 so that the rotation position of the mode cam 40 varies depending on the opening position of the temperature door 15 for the cold air flow path 10b.

In addition, the defrosting door slot 42 of the mode cam 40 has a floor mode section C1 that controls the opening position of the defrosting door 16 so as to be further opened when the mode cam 40 rotates to the temperature difference compensation mode position as illustrated in FIG. 10. The floor mode section C1 has a trajectory that causes the opening degree of the defrosting vent 16a to vary depending on the rotation position of the mode cam 40, which varies depending on the opening position of the temperature door 15.

In particular, The floor mode section C1 has a trajectory that variably controls the rotation position of the mode cam 40 in accordance with the change in the opening position of the temperature door 15 which is controlled so as to reduce the cold air flow path 10b, and controls the rotation position of the mode cam 40 so as to increase the opening degree of the defrosting door 16 for the defrosting vent 16a in inverse proportion to the decrease in the opening position of the temperature door 15 as shown in FIG. 12 (see “I”).

Therefore, when controlling a specific opening position range R of the temperature door 15 under the floor mode condition, the opening degree of the defrosting door 16 for the defrosting vent 16a can be increased in inverse proportion to the decrease in the opening position of the temperature door 15 for the cold air flow path 10b.

The reason for this control is that, as the opening degree of the cold air flow path 10b decreases, the amount of air flowing toward the defrosting vent 16a is relatively small, and therefore the cold air of the upper cold air flow path portion 10b-1 flows toward the defrosting vent 16a without being sufficiently mixed with the hot air of the upper hot air flow path portion 10c-1.

Accordingly, as the opening degree of the cold air flow path 10b decreases, the opening degree of the defrosting vent 16a is increased, thereby increasing the air flow rate on the defrosting vent 16a side as the opening degree of the cold air flow path 10b decreases. This increases the mixing efficiency between the cold air and the hot air in the upper cold and hot air flow path portions 10b-1 and 10c-1.

As a result, the temperature difference between the discharged air on the defrosting vent 16a side and the discharged air on the floor vent 18a side can be eliminated by inducing an increase in the temperature of the discharged air on the defrosting vent 16a side.

Referring again to FIGS. 8 and 9, the mode cam control part 70 enters the temperature difference compensation mode to control the mode cam 40 so as to further open the defrosting door 16, and continuously receives the opening position of the temperature door 15 in real time from the temperature door opening position detection part 50.

At this time, if the opening position of the temperature door 15 for the cold and hot air flow paths 10b and 10c is not included in a preset specific range, for example, if the opening degree of the temperature door 15 for the cold air flow path 10 b does not fall within a range of 40% or more of a preset lower limit and 67% or less of a preset upper limit, the mode cam control part 70 is released from the temperature difference compensation mode.

The mode cam control part 70 released from the temperature difference compensation mode controls the rotation position of the mode cam 40 so as to return the opening position of the defrosting door 16 to the opening position available before entering the temperature difference compensation mode.

Next, an operation example of the vehicular air conditioner having such a configuration will be described in detail with reference to FIGS. 8 to 13.

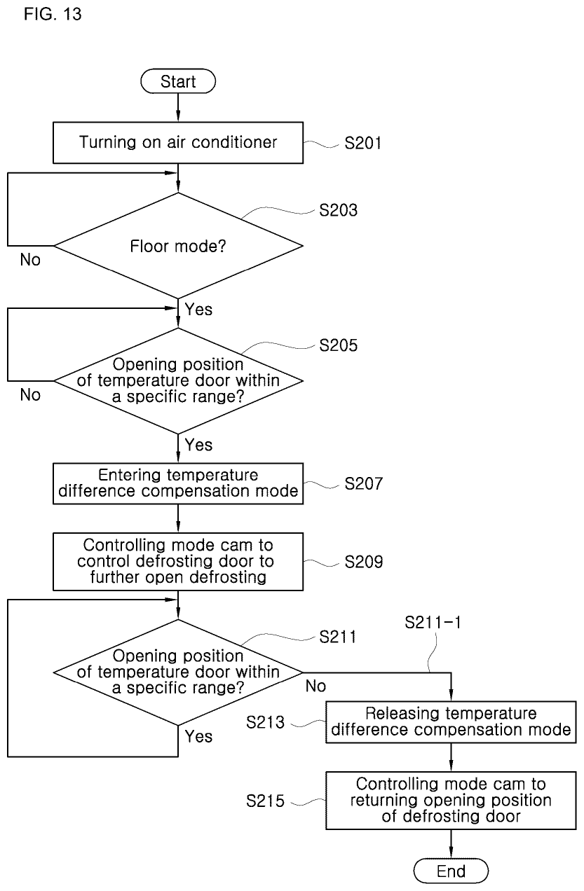

Referring first to FIG. 13, when the air conditioner is turned on (S201), the mode cam control part 70 determines whether the current air discharge mode is a floor mode (S203).

As a result of the determination, if the current air discharge mode is the floor mode, the mode cam control part 70 determines whether the opening position of the temperature door 15 for the cold and hot air flow paths 10b and 10c falls within a preset specific range (S205).

For example, the mode cam control part 70 determines whether the opening degree of the temperature door 15 for the cold air flow path 10b falls within a range of 40% or more of a preset lower limit and 67% or less of a preset upper limit.

As a result of the determination, if the opening degree of the temperature door 15 for the cold air flow path 10 b falls within the range of 40% or more of the preset lower limit and 67% or less of the preset upper limit, the mode cam control part 70 recognizes that most of the cold air on the current cold air flow path 10b side flows toward the defrosting vent 16a, and an excessive temperature difference is generated between the discharged air on the defrosting vent 16a side and the discharged air on the floor vent 18a side. Based on this recognition, the mode cam control part 70 enters a temperature difference compensation mode (S207).

The mode cam control part 70, which has entered the temperature difference compensation mode, controls the rotation position of the mode cam 40 so that the opening position of the defrosting door 16 is controlled so as to further open the defrosting vent 16a by a preset degree (S209).

Then, as shown in FIG. 9, the mode cam 40 is rotated to a temperature difference compensation mode position, in response to which the defrosting door 16 connected to the defrosting door slot 42 of the mode cam 40 is controlled so as to further open the defrosting vent 16a.

Accordingly, the amount of air flowing toward the defrosting vent 16a is relatively increased. Thus, the cold air of the upper cold air flow path portion 10b-1 is sufficiently mixed with the hot air of the upper hot air flow path portion 10c-1 in the first air mixing area A1 and then flows toward the defrosting vent 16a.

As a result, the temperature of the air flowing toward the defrosting vent 16a increases, and the temperature of the air discharged into the passenger room from the defrosting vent 16a increases.

Accordingly, the excessive temperature difference between the discharged air on the defrosting vent 16a side and the discharged air on the floor vent 18a side, which is generated when the temperature door 15 is controlled to a specific opening position range under the floor mode condition is compensated and eliminated.

Meanwhile, after entering the temperature difference compensation mode, the mode cam control part 70 continuously determines whether the opening position of the temperature door 15 for the cold and hot air flow paths 10b and 10c falls within a preset specific range (S211).

At this time, if the opening position of the temperature door 15 does not fall within the preset specific range (S211-1), the mode cam control part 70 is released from the temperature difference compensation mode (S213).

The mode cam control part 70, which is released from the temperature difference compensation mode, controls the rotation position of the mode cam 40 so that the opening position of the defrosting door 16 can be returned to the opening position available before entering the temperature difference compensation mode (S215).

According to the vehicular air conditioner of the present invention having such a configuration, the defrosting vent 16a is further opened when the temperature door 15 is controlled to fall within a specific opening position range under the floor mode condition. Therefore, it is possible to prevent the excessive flow of the cold air toward the defrosting vent 16a side, which may occur during the control of the temperature door 15 to the specific opening position range under the floor mode condition.

In addition, since the excessive flow of the cold air toward the defrosting vent 16a side can be prevented during the control of the temperature door 15 to the specific opening position range under the floor mode condition, it is possible to prevent the excessive temperature difference between the discharged air temperature on the floor vent 18a side and the discharged air temperature on the defrosting vent 16a side, which may occur during the control of the temperature door 15 to the specific opening position range under the floor mode condition.

In addition, since the excessive temperature difference between the discharged air temperature on the floor vent 18a side and the discharged air temperature on the defrosting vent 16a side can be prevented during the control of the temperature door 15 to the specific opening position range under the floor mode condition, it is possible to prevent the decrease in comfort in the passenger room due to the excessive temperature difference between the discharged air temperature on the floor vent 18a side and the discharged air temperature on the defrosting vent 16a side.

While the preferred embodiments of the present invention have been described above, the present invention is not limited to the above-described embodiments. Various modifications and changes may be made without departing from the scope and spirit of the present invention defined in the claims.

1. A vehicular air conditioner, comprising:
a temperature door configured to control temperature of air discharged into a passenger room by controlling an opening degree of a cold air flow path of an air conditioning case and an opening degree of a hot air flow path of the air conditioning case;
mode doors installed in discharge vents and configured to control a discharge direction of the air with respect to the passenger room according to air discharge modes; and
a control part configured to variably control opening positions of the mode doors according to the opening position of the temperature door for the cold and hot air flow paths.

2. The vehicular air conditioner of claim 1, wherein the discharge vents include a defrosting vent, a face vent and a floor vent,
the mode doors include a defrosting door configured to control an opening degree of the defrosting vent, a face door configured to control an opening degree of the face vent and a floor door configured to control an opening degree of the floor vent, and
the control part is configured to variably control an opening position of the defrosting door according to an opening position of the temperature door for the cold and hot air flow paths.

3. The vehicular air conditioner of claim 2, wherein when the opening position of the temperature door for the cold and hot air flow paths is controlled to fall within a specific range under a floor mode condition in which the floor vent and the defrosting vent are opened and the face vent is closed, the control part enters a temperature difference compensation mode and controls the opening position of the defrosting door among the mode doors so as to further open the defrosting vent by a preset degree.

4. The vehicular air conditioner of claim 3, wherein when the opening position of the temperature door for the cold air flow path falls within a range of a preset lower limit or higher and a preset upper limit or lower under the floor mode condition, the control part enters the temperature difference compensation mode and controls the opening position of the defrosting door so as to further open the defrosting vent by a preset degree.

5. The vehicular air conditioner of claim 4, wherein the control part enters the temperature difference compensation mode to control the defrosting door so as to further open the defrosting vent so that the opening position of the defrosting door for the defrosting vent varies depending on the opening position of the temperature door for the cold and hot air flow paths.

6. The vehicular air conditioner of claim 5, wherein when entering the temperature difference compensation mode, the control part controls the opening degree of the defrosting door for the defrosting vent so as to increase in inverse proportion to a decrease in the opening degree of the temperature door for the cold air flow path.

7. The vehicular air conditioner of claim 5, wherein when the opening position of the temperature door for the cold and hot air flow paths does not fall within a preset specific range after entering the temperature difference compensation mode, the control part is released from the temperature difference compensation mode to return the opening position of the defrosting door to the opening position available before entering the temperature difference compensation mode.

8. The vehicular air conditioner of claim 7, wherein the preset specific range of the temperature door for the cold and hot air flow paths set for entering the temperature difference compensation mode is a range in which the opening degree of the temperature door for the cold air flow path is 40% or more of a preset lower limit and 67% or less of a preset upper limit.

9. The vehicular air conditioner of claim 8, wherein the cold air flow path is divided into upper and lower cold air flow path portions with the hot air flow path interposed therebetween in an internal flow path of the air conditioning case,
the temperature door includes a first temperature door configured to slide between the upper cold air flow path portion and an upper portion of the hot air flow path to adjust an opening degree of the upper cold air flow path portion and the upper portion of the hot air flow path, and a second temperature door configured to slide between the lower cold air flow path portion and a lower portion of the hot air flow path to adjust an opening degree of the lower cold air flow path portion and the lower portion of the hot air flow path, and
the control part is configured to enter the temperature difference compensation mode and control the opening position of the defrosting door so as to further open the defrosting vent by a preset degree when the opening positions of the first temperature door and the second temperature door for the cold and hot air flow paths are controlled to fall within the specific range under the floor mode condition.

10. The vehicular air conditioner of claim 1, wherein the cold air flow path includes an upper cold air flow path portion and a lower cold air flow path portion,
the hot air flow path includes an upper hot air flow path portion and a lower hot air flow path portion, and
the control part is configured to enter the temperature difference compensation mode and control the mode doors so as to allow a larger amount of air to flow toward the upper hot air flow path portion when the opening position of the temperature door for the cold and hot air flow paths is controlled to fall within a specific range under a floor mode condition.

11. The vehicular air conditioner of claim 10, wherein when entering the temperature difference compensation mode, the control part performs control so as to further open at least one of the mode doors on the downstream side of the upper cold and hot air flow paths.

12. The vehicular air conditioner of claim 1, further comprising:
a mode cam configured to adjust the positions of the mode doors according to a rotation position of the mode cam so as to control the mode doors in a specific air discharge mode,
wherein the control part is configured to control the mode cam so as to change the opening positions of the mode doors depending on the opening position of the temperature door for the cold and hot air flow paths.

13. The vehicular air conditioner of claim 12, wherein the discharge vents include a defrosting vent, a face vent and a floor vent,
the mode doors include a defrosting door configured to control an opening degree of the defrosting vent, a face door configured to control an opening degree of the face vent and a floor door configured to control an opening degree of the floor vent, and
the control part is configured to control the mode cam so as to change the opening position of the defrosting door when the opening position of the temperature door for the cold and hot air flow paths is controlled to fall within a specific range.

14. The vehicular air conditioner of claim 13, wherein the mode cam has a plurality of slots configured to control the positions of the mode doors when rotated,
the control part includes a mode cam control part configured to enter a temperature difference compensation mode and rotate the mode cam to a temperature difference compensation mode position when the opening position of the temperature door for the cold and hot air flow paths falls within a range of a preset lower limit or higher and a preset upper limit or lower under a floor mode condition in which the floor vent and the defrosting vent are opened and the face vent is closed, and
the slots of the mode cam are formed so as to change the opening position of the defrosting door among the mode doors when the mode cam is rotated to the temperature difference compensation mode position.

15. The vehicular air conditioner of claim 14, wherein the slots of the mode cam include a defrosting door slot configured to control the opening position of the defrosting door on the window side, a vent door slot configured to control the opening position of the vent door on the passenger face side, and a floor door slot configured to control the opening position of the floor door on the floor surface side in the passenger room,
each of the slots has a floor mode section for controlling each of the mode doors at a floor mode position to move to a specific opening position,
the floor mode sections of the vent door slot and the floor door slot are configured to have idle rotation trajectories having the same distance from a central axis of the mode cam so as not to change the opening positions of the vent door and the floor door when the mode cam is rotated to the temperature difference compensation mode position, and
the floor mode section of the defrosting door slot is configured to have a curved trajectory with different distances from the center axis of the mode cam so as to change the opening position of the defrosting door when the mode cam is rotated to the temperature difference compensation mode position.

16. The vehicular air conditioner of claim 15, wherein the floor mode section of the defrosting door slot has a trajectory that allows the defrosting door to move so as to further open the defrosting vent by a preset degree when the mode cam is rotated to the temperature difference compensation mode position.

17. The vehicular air conditioner of claim 16, wherein the mode cam control part and the defrosting door slot are configured to control the defrosting door so as to further open the defrosting vent when entering the temperature difference compensation mode, so that the opening position of the defrosting door for the defrosting door varies depending on the opening position of the temperature door for the cold and hot air flow paths.

18. The vehicular air conditioner of claim 17, wherein the mode cam control part and the defrosting door slot are configured to, when entering the temperature difference compensation mode, increase the opening degree of the defrosting door for the defrosting vent in inverse proportion to a decrease in the opening degree of the temperature door for the cold air flow path.

19. The vehicular air conditioner of claim 18, wherein the mode cam control part is configured to, when entering the temperature difference compensation mode, rotate the mode cam to the temperature difference compensation mode position and variably control the rotation position of the mode cam so as to vary depending on the opening position of the temperature door for the cold air flow path,
the defrosting door slot has a floor mode section that controls the opening position of the defrosting door so as to further open the defrosting vent when the mode cam is rotated to the temperature difference compensation mode position, and
the floor mode section has a trajectory that controls the opening degree of the defrosting door for the defrosting vent to increase in inverse proportion to a decrease in the opening degree of the temperature door for the cold air flow path so that the rotation position of the mode cam is variably controlled in accordance with a change in the opening position of the temperature door.

20. The vehicular air conditioner of claim 19, wherein when the opening position of the temperature door for the cold and hot air flow paths does not fall within a preset specific range after entering the temperature difference compensation mode, the mode cam control part is released from the temperature difference compensation mode to return the opening position of the defrosting door to the opening position available before entering the temperature difference compensation mode.

21. The vehicular air conditioner of claim 20, wherein the preset specific range of the temperature door for the cold and hot air flow paths set for entering the temperature difference compensation mode is a range in which the opening degree of the temperature door for the cold air flow path is 40% or more of a preset lower limit and 67% or less of a preset upper limit.

22. The vehicular air conditioner of claim 21, wherein the cold air flow path is divided into upper and lower cold air flow path portions with the hot air flow path interposed therebetween in an internal flow path of the air conditioning case,
the temperature door includes a first temperature door configured to slide between the upper cold air flow path portion and an upper portion of the hot air flow path to adjust an opening degree of the upper cold air flow path portion and the upper portion of the hot air flow path, and a second temperature door configured to slide between the lower cold air flow path portion and a lower portion of the hot air flow path to adjust an opening degree of the lower cold air flow path portion and the lower portion of the hot air flow path, and
the control part is configured to enter the temperature difference compensation mode and control the mode cam so as to allow the defrosting door so as to further open the defrosting vent by a preset degree when the opening positions of the first temperature door and the second temperature door for the cold and hot air flow paths are controlled to fall within the specific range under the floor mode condition.

23. The vehicular air conditioner of claim 12, wherein the cold air flow path includes an upper cold air flow path portion and a lower cold air flow path portion,
the hot air flow path includes an upper hot air flow path portion and a lower hot air flow path portion, and
the control part is configured to enter the temperature difference compensation mode and control the mode cam for the mode doors so as to allow a larger amount of air to flow toward the upper hot air flow path portion when the opening position of the temperature door for the cold and hot air flow paths is controlled to fall within a specific range under a floor mode condition.

24. The vehicular air conditioner of claim 23, wherein when entering the temperature difference compensation mode, the control part controls the mode cam so as to further open at least one of the mode doors on the downstream side of the upper cold and hot air flow paths.
